(19) United States
(12) Patent Application Publication
(10) Pub. No.: US 2015/0339881 A1
(43) Pub. Date: Nov. 26, 2015

(54) GAMING MACHINE AND GAME HAVING SYMBOLS WITH INCREASING VALUES

(71) Applicant: Salvatore Falciglia, SR., Ridgewood, NJ (US)

(72) Inventor: Salvatore Falciglia, SR., Ridgewood, NJ (US)

(21) Appl. No.: 14/711,999

(22) Filed: May 14, 2015

Related U.S. Application Data
(60) Provisional application No. 62/002,581, filed on May 23, 2014.

(51) Int. Cl. G07F 17/32; G07F 17/34

(52) U.S. Cl. CPC G07F 17/3213; G07F 17/34

(57) ABSTRACT

In a method of playing a game at a gaming machine, a first set of symbols is displayed and winnings are paid for combinations of winning symbols. A second set of symbols is displayed by removing the winning combinations of symbols and replacing them with new symbols. The value of awards for symbols of the type which did not form a winning combination relative to the first set of symbols is higher for the second set of symbols than if those symbols had formed a winning combination in the first set of symbols.

### PRIOR APPLICATION DATA

This application claims priority to U.S. Provisional Patent Application Ser. No. 62/002,581, filed May 23, 2014.

### FIELD OF THE INVENTION

The present invention relates to gaming machines and methods of playing and presenting games.

### BACKGROUND OF THE INVENTION

Game players continue to seek new and exciting games. Relative to wagering games, game players enjoy games which present new and exciting ways to obtaining winning awards.

A new and exciting game is desired.

### SUMMARY OF THE INVENTION

Embodiments of the invention comprise methods of playing and presenting games and gaming machines for presenting games.

In one embodiment of the invention, games are played as wagering games in which a player places a wager and the wager is accepted for playing the game.

In one embodiment of the invention, a first set of game symbols is displayed, such as via an electronic video display of a gaming machine. The first set of game symbols is preferably selected from different types of symbols.

The first set of game symbols is evaluated for first winning combinations. Each first winning combination preferably comprises a plurality of the same type of game symbol, such as two, three or more of the symbols of the same type. In one embodiment, symbols of the same type must be in linked or connected display positions. Each first winning combination of symbols has a base award. If there are no first winning combinations, the game preferably ends. If there are first winning combinations, the base award is awarded for each winning combination.

If there are first winning combinations, the base award is awarded for each winning combination. A second set of game symbols is then displayed, the second set of game symbols comprising the first set of game symbols with each symbol forming a first winning combination therein removed and replaced with a new symbol. The second set of game symbols is then evaluated for second winning combinations. The second winning combinations of symbols are preferably defined to be the same combinations of symbols which are designated as first winning combinations of symbols. However, if a second winning combination of symbols is received which comprises a combination of symbols of the type which formed any first winning combination of symbols, a base award is awarded. If a second combination of symbols is received which comprises a combination of symbols of a type which did not form a first winning combination of symbols, an enhanced award which is greater than the base award is awarded.

In accordance with the invention, different symbols may be displayed in a first set of game symbols. The types of symbols which form any first winning combination of symbols may be designated a “winning” symbol type and the remaining symbol types may be designated to be losing types. If combinations of any of the losing symbol types are obtained in the second set of game symbols, the player receives an award which is greater than the award would have been if a winning combination of that symbol type had been obtained in the first set of game symbols. Thus, in a second round of game play, excitement of the game increases because the types of symbols which did not initially form a game win may result in a game win with an increased payout or award.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine in accordance with the present invention;

FIG. 2 is a flowchart illustrating one embodiment of a method of playing and presenting a game in accordance with an embodiment of the invention; and

FIGS. 3-5 illustrate an example of a game in accordance with the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and game presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

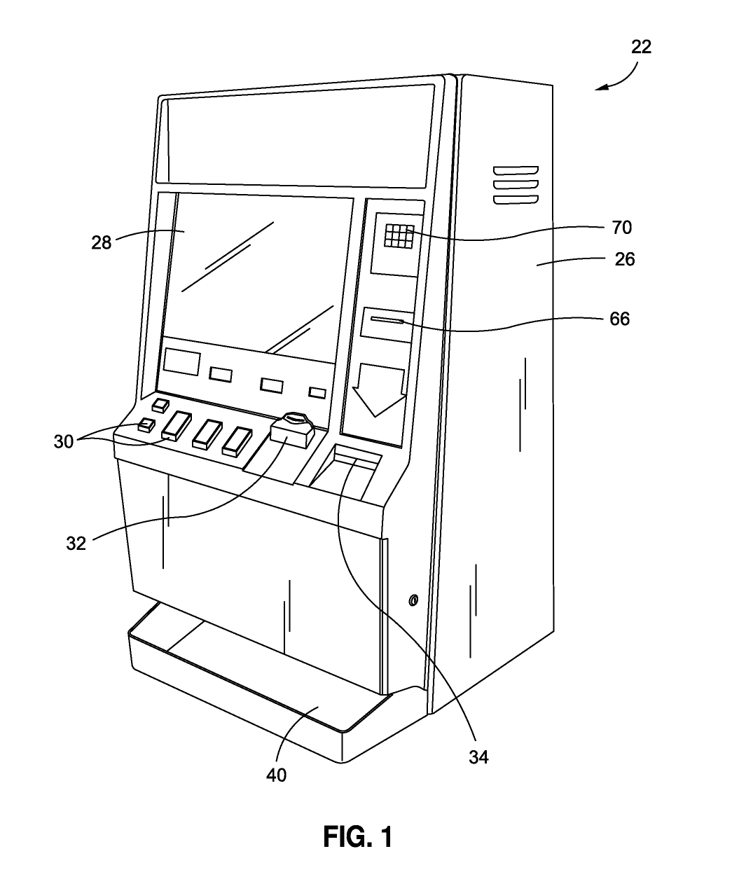

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of slot reels or slot symbols, such as described below), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting game symbols and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game symbols to be displayed on the at least one display 28. The controller may accept input from a player of other game inputs via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins.

Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

A casino may have numerous such gaming machines 22, such as located on a casino floor or in other locations. Of course, such gaming machines 22 might be used in other environments, such as an airport, a bar or tavern or other locations.

It is possible for the game of the invention to be presented on a computing device, including at a home or office computer or a player's mobile electronic device such as a PDA, phone, tablet or the like. In this regard, the term “gaming machine” or “gaming device” may include other devices, such as personal computing type devices. In one embodiment, a player might log in to a casino server and the controller of the casino server may cause game information to be delivered to the player's computing device via a communication link and then be displayed on a display of the player's computing device. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computing device. The local controller at the gaming machine or the player's computer or other electronic device may then cause game information to be displayed on one or more associated displays.

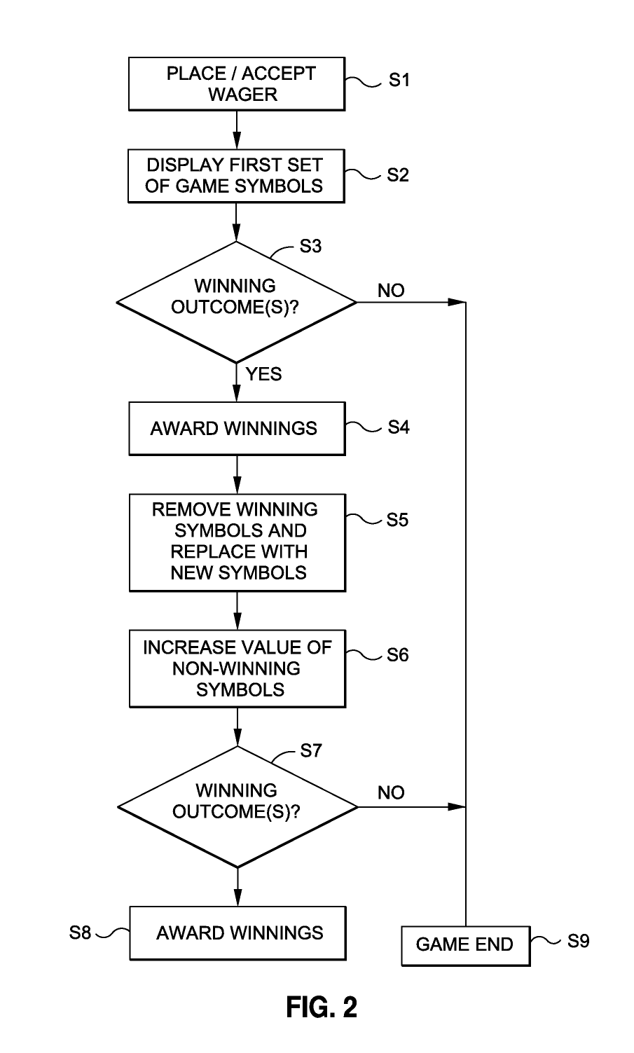

One embodiment of a method of the invention will be described with reference to FIG. 2. In a step S1, the game may begin by a player placing a wager. The wager may be placed in monetary funds or monetary funds equivalents (credits), points or the like. As indicated above, a gaming device may be configured to accept funds in various manners. The player may be required to place a minimum wager and the game may have a maximum wager. The size of the player's wager may affect the size of winnings paid to the player for winning game outcomes.

In a step S2, a first set of game symbols is displayed to the player, such as via an electronic video display of the gaming device. In a preferred embodiment, the first set of game symbols is selected from a set of at least two different game symbols or two different types of game symbols (e.g. game symbols having different appearances or other characteristics). The first set of game symbols may be displayed in various arrangements, such as in a matrix format.

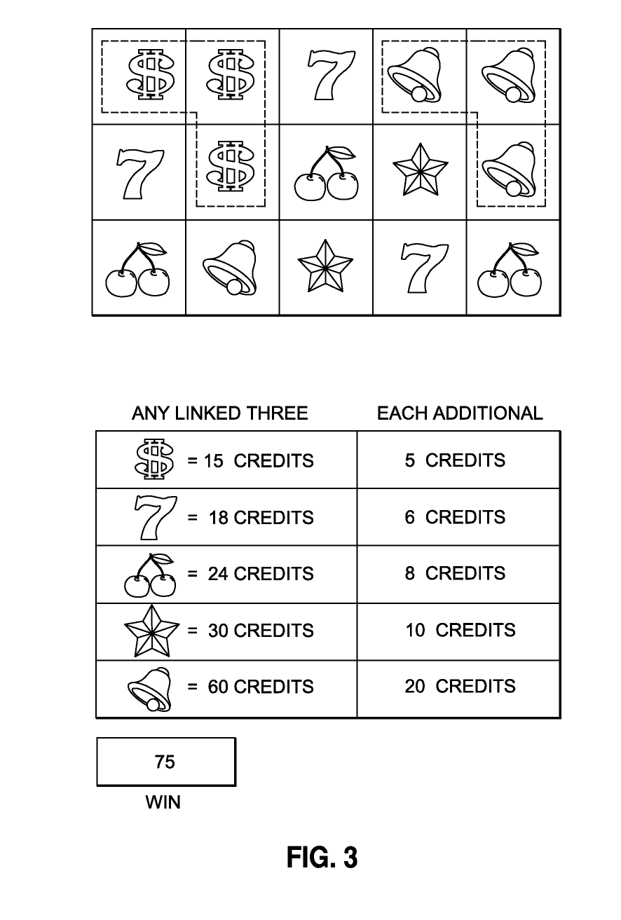

FIG. 3 illustrates one example of the invention wherein the game symbols used in the play of the game comprise the symbols $, 7, CHERRY, BELL, and STAR. In this example, the game symbols are displayed in a 3×5 matrix (3 rows by 5 columns, for a total of 15 game symbols). However, the matrix could be of any size of n rows by m columns, or be irregular in shape (pyramid, etc.).

Preferably, the game symbols are randomly selected. The game symbols might be selected on a position by position basis or in combinations by row, column or the like.

Referring again to FIG. 2, in a step S3, it is determined if the first set of game symbols defines or comprises any winning combinations of game symbols. In a preferred embodiment, winning combinations of symbols are defined as a minimum number of the same game symbol, preferably being at least 2 of the same type of game symbol. For example, in one embodiment, a winning combination might comprise at least 2, 3 or more of the same game symbol anywhere in the displayed set of game symbols (e.g. a “scatter” of the game symbols).

In a most preferred embodiment, winning combinations of symbols are defined as a minimum number of the same game symbol in connected, joined or linked positions (e.g. the symbols or their positions touch or connect, such as along common sides, top, bottom, and/or diagonally). In a preferred embodiment, the winning combination comprises at least 3 of the same game symbol in connected, joined or linked positions.

If there are no winning combinations relative to the first set of game symbols, then the game preferably ends, as in step S9.

FIG. 3 illustrates an example where winning outcomes comprise 3 or more of the same game symbol in connected, joined or linked positions. In this example, two such winning outcomes are defined: three $ symbols and three BELL symbols.

Referring again to FIG. 2, in a step S4, winnings are preferably awarded to the player for any winning outcomes, such as based upon designated symbol values or winning outcome values. In a preferred embodiment, each first winning combination of symbols (combinations relative to the first set of game symbols) has an associated value or award. In one embodiment, there is a base or first value or award for each winning combination of symbols relative to the first set of displayed game symbols. For example, as illustrated in FIG. 3, relative to the first set of displayed game symbols, each $ symbol has a value of 5 credits, so that winning combinations of three $ symbols have an associated award of 15 credits (and combinations of more than four $ symbols have an award equal to the number of symbols multiplied by 5 credits—e.g. four $ symbols has an award of 20 credits, etc). As illustrated, each different type of game symbol (or winning combinations of those game symbols) may have a different value or game symbols may have the same value. The values or awards may be reflected by a first pay table (which may be displayed to the player). In this example, the winning combinations of three $ symbols (having an award of 15 credits) and three BELL symbols (having an award of 60 credits) have resulted in a total win or award of 75 credits to the player.

In a step S5, a second set of game symbols is displayed, such as via the display of the gaming device. Preferably, the game symbols which formed first winning outcomes or combinations are removed from the first set of game symbols and are replaced with new game symbols. The second set of game symbols thus comprises the game symbols from the first set of game symbols which did not comprise a first winning outcome, plus replacement symbols for winning game symbols which were removed from the first set of game symbols.

The step of removing and replacing game symbols may be accomplished and displayed in various manners. For example, animation might be used to cause the symbols to appear to explode, disappear, etc. Replacement symbols may be displayed in various manners as well. In a preferred embodiment, replacement game symbols are randomly generated or selected (it will thus be appreciated that in a preferred configuration, the replacement symbols might be the same as those which they replace).

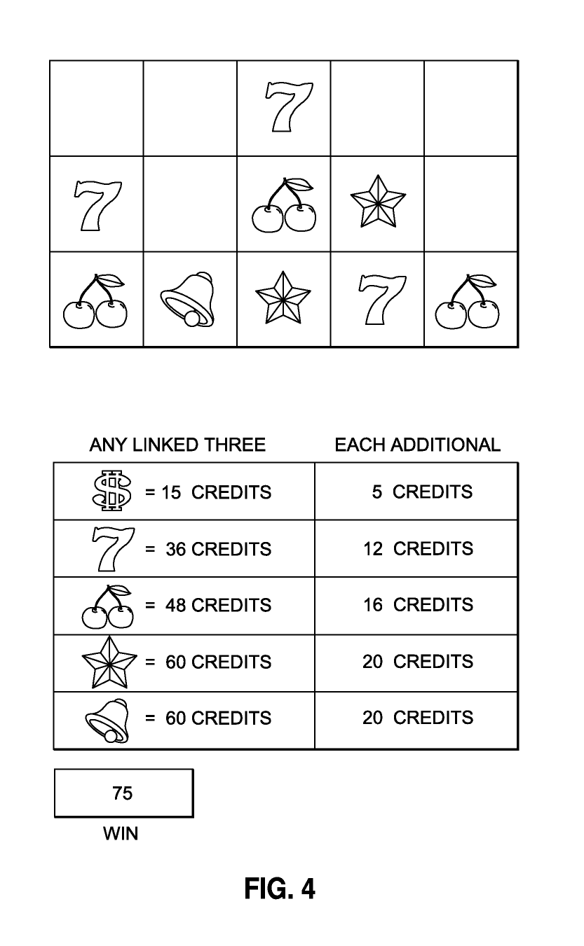

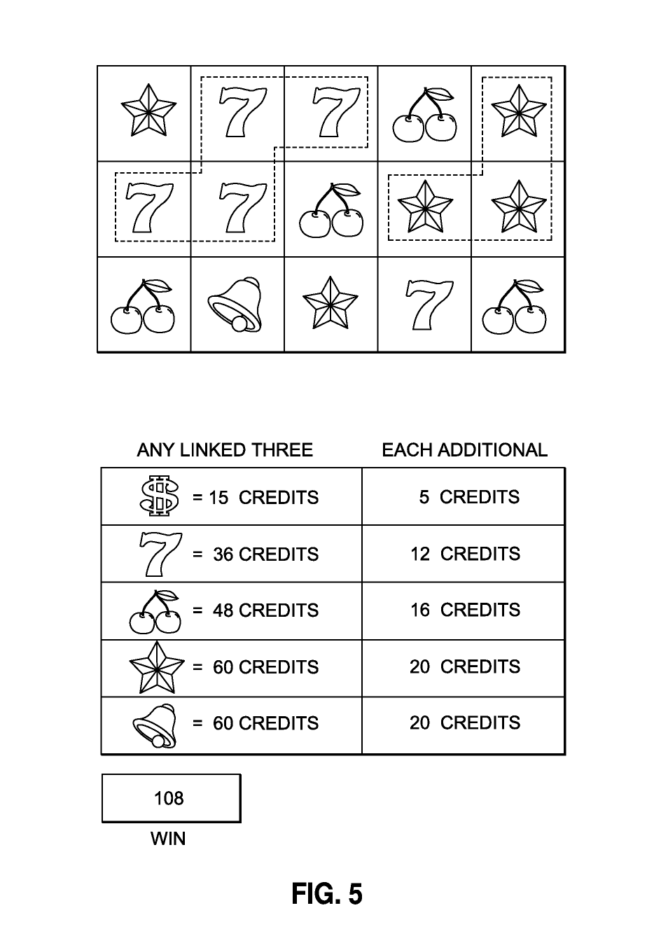

FIG. 4 illustrates an example of game play where the winning $ and BELL symbols from the first set of game symbols have been removed. FIG. 5 illustrates an example of game play where the removed symbols have been replaced with new game symbols, thus forming a second set of game symbols.

Referring again to FIG. 2, in a step S6, the value of one or more of the game symbols, or combinations thereof, is different relative to the second set of game symbols than in the first set of game symbols. In one embodiment, the value of one or more of the symbols (such as with reference to a winning combination of those symbols) is increased.

Game symbols of the type which resulted in winning outcomes relative to the first set of game symbols may be referred to as “winning” symbols, and the game symbols of the type which did not result in winning outcomes relative to the first set of game symbols may be referred to as “losing” symbols. In a preferred embodiment, the value of “losing” type of symbols (or combination thereof) increases so that awards or winnings for winning combinations of losing types of symbols is higher relative to the second set of game symbols than if a winning outcome of those game symbols had been received in the first set of game symbols.

For example, relative to the example illustrated in FIGS. 3-5, the $ and BELL symbols comprised winning types of game symbols relative to the first set of game symbols. The losing types of game symbols comprised the 7, CHERRY and STAR symbols. Relative to the first set of game symbols, the value of the 7 symbol was 6 credits, the CHERRY symbol was 8 credits and the STAR symbol was 10 credits. However, because the 7, CHERRY and STAR game symbols were not winning relative to the first set of game symbols, their value has preferably increased. Relative to the second set of game symbols, the value of the 7 symbol has increased to 12 credits, the value of the CHERRY symbol has increased to 16 credits and the value of the STAR symbol has increased to 20 credits. Thus, winning outcomes or combinations of the game symbols which were of the losing type relative to the first set of game symbols have a higher value relative to the second set of game symbols. Preferably, winning outcomes or combinations of game symbols which were of the winning type relative to the first set of game symbols have the same value (relative to the second set of symbols as compared to the first set of symbols, although their value could also decrease). Of course, the value of each individual losing game symbol need not increase relative to the second set of game symbols, but preferably the award for any winning combinations of such a losing symbol is higher relative to the second set of game symbols than relative to the first set of game symbols. Further, the increase in award value could be different for different symbols or combinations thereof (in the example illustrated in FIG. 5, the value of the losing symbols has doubled, but the values could increase by other amounts and the increase in value need not be the same for each symbol). The value or awards may be reflected by a second or modified pay table (which may be displayed to the player).

In a step S7, the second set of game symbols is evaluated for one or more winning outcomes or combinations of symbols. In a preferred embodiment, winning outcomes again comprise combinations of 2 or more of the same game symbol, and most preferably 2 or more of the same game symbol in connected, joined or linked positions.

In the example illustrated in FIG. 5, a winning combination of four 7 symbols has been generated, as well as a winning combination of three STAR symbols.

Referring again to FIG. 2, in a step S7, winnings or other awards are preferably awarded to the player for any winning outcomes or combinations relative to the second set of game symbols. In this case, the winning outcome of four 7 symbols results in an award of 48 credits and the winning outcome of three STAR symbols results in an award of 60 credits, for a total win or award to the player of 108 credits.

The game may then end, or it could continue to one or more additional “rounds” of play. For example, each winning combination of symbols in the second set of game symbols could be removed and then replacement symbols could be provided to generate a third set of game symbols. In one embodiment, the value of any losing type of symbol relative to the first and second set of game symbols again increases relative to the third set of game symbols (while types of symbols which were winning relative to the first or second sets of game symbols preferably retain their current value).

It will be appreciated that some types of game symbols may not appear in the first set of symbols (such as if no STAR symbol appeared in the first set of game symbols in the example illustrated in FIG. 3). In that event, that type of symbol might be treated as winning or, preferably, as a losing type relative to the second set of symbols. In another embodiment, such symbols might have the same value.

While in a preferred embodiment of the invention only the winning symbols are removed from an existing set of symbols before the next set of symbols is generated or displayed, other configurations are possible. The invention may be applied to full “respins” of game symbols. For example, in one embodiment a first set of symbols might be generated and displayed and then evaluated for wins. A second set of symbols might then be generated and displayed independent of the first set of symbols (e.g. all symbols in the second set could be randomly generated and displayed rather than only removing and generating replacement symbols for the winning symbols in the first set of symbols). The newly generated and displayed second set of symbols would then be evaluated for wins, preferably where symbols which were “losing” in the first set have a higher value relative to wins in the second set and the symbols which were winning in the first set have a lower value relative to wins in the second set.

It will also be appreciated that winning combinations of symbols might comprise other than linked symbols, such as certain patterns of symbols, symbols in certain locations, symbols along certain pay lines or the like.

Of course, yet other configurations of the invention are possible where a first set of symbols is evaluated and a second set of symbols is evaluated (and where the first and second sets of symbols may be generated in various manners and may or may not have common symbols) and wherein the value of the symbols or combinations of symbols may change as described herein.

The game and gaming machine of the invention have numerous benefits. An important aspect of the invention is that a player may have more than one chance to obtain winning combinations. In particular, if one or more winning combinations are received relative to a first set of game symbols, a second set of game symbols is displayed and evaluated for potential additional winning combinations.

In addition, a player has the opportunity for higher awards relative to winning outcomes for “losing” symbols from the first set of game symbols. Thus, if a player obtains one or more winning combinations relative to the first set of game symbols, the player knows that they have an opportunity for higher value awards if the losing symbols from the first set of game symbols end up defining a winning outcome relative to the next round of play (in which the second set of symbols is displayed an evaluated). This feature adds significant excitement to the play of the game.

One aspect of the invention is the unexpected feature of higher awards relative to symbols which have a higher probability of winning In particular, once winning symbol combinations are removed from a set of game symbols there is a lower probability that those symbol positions will be filled with the same winning symbols than there is for the symbol positions to be filled with symbols which form winning combinations with the remaining losing symbols. In other words, there is a higher probability of obtaining a win relative to the losing symbols in a subsequent round. Traditionally, wagering games offer increased or higher awards only when there is a lower or reduced probability of receiving the winning outcome. In this game, however, higher awards may be received relative to outcomes which have a higher probability of occurring.

In one embodiment, a player may be required to place an additional wager in order to play each additional round of the game and be entitled to the potential higher awards. For example, if the player obtains one or more winning combinations relative to the first set of game symbols, the player may be asked “would you like to place an additional wager to continue play and have the opportunity for higher awards?”. Because the game offers the opportunity for higher awards relative to the losing symbols, a game operator can seek an additional wager from players to play additional rounds of the game (thus increasing revenue to the game operator).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine configured to present a game comprising:
a controller;
at least one electronic display;
at least one player input device;
machine-readable code executable by said controller to cause said at least one electronic display to display a first set of game symbols, said first set of game symbols selected from at least a first type of game symbol and a second type of game symbol;
machine-readable code executable by said controller to cause said controller to determine if combinations of symbols in said first set of symbols comprise at least one first winning combination of symbols, wherein each first winning combination of symbols comprises a plurality of the same type of game symbol and wherein each first winning combination of symbols has an associated base payout;
machine-readable code executed by said controller to end said game if no first winning combination of symbols exists;
machine-readable code executable by said controller to cause said controller to award said base payout corresponding to each first winning combination of symbols which is received in said first set of game symbols;
machine-readable code executable by said controller to cause said at least one electronic display to display a second set of game symbols comprising said first set of game symbols with symbols forming each first winning combination of symbols removed and replaced with replacement symbols selected from said at least a first type of game symbol and a second type of game symbol; and
machine-readable code executable by said controller to cause said controller to determine if at least one combination of game symbols in said second set of symbols comprises a second winning combination of symbols, wherein each second winning combination of symbols comprising a plurality of the same game symbols and wherein each second winning combination of symbols has a base payout if the second winning combination of symbols comprises combinations of any game symbol type which resulted in a first winning combination of symbols and having an enhanced payout greater than said base payout if the second winning combination of symbols comprises combinations of any game symbol type which was displayed in said first set of game symbols but was not a type of symbol which formed a first winning combination.

2. The gaming machine in accordance with claim 1 wherein said at least one first winning combination of symbols comprises at least three of the same type of game symbol.

3. The gaming machine in accordance with claim 2 wherein said at least three of the same type of game symbol must be in linked positions.

4. The gaming machine in accordance with claim 2 wherein said first set of game symbols is displayed in a matrix of rows and columns and said at least three of the same type of game symbol must connect along one or more of said rows or columns.

5. A method of presenting a game at a gaming machine having at least one electronic video display, comprising the machine implemented steps of:
displaying a first set of game symbols, said first set of game symbols selected from a group of game symbols including at least one first game symbol and at least one second game symbol;
determining if said first set of game symbols includes at least one predetermined first winning combination of game symbols, wherein each first winning combination of symbols comprises two or more of the same game symbol and wherein each predetermined first winning combination of game symbols has an associated base award;
awarding said base award for each received first winning combination of symbols in said first set of game symbols;
if at least one first winning combination of symbols is received in said first set of game symbols, displaying a second set of game symbols comprising said first set of game symbols with each symbol forming a first winning combination of symbols removed and replaced with a symbol selected from said group of symbols;
determining if said second set of game symbols includes at least one predetermined second winning combination of game symbols, wherein each second winning combination of symbols comprises two or more of the same game symbol and wherein each predetermined winning combination of game symbols formed from symbols which did not form a received first winning combination of symbols has an increased award greater than said base award and each predetermined winning combination of game symbols formed from symbols which did form a received first winning combination of symbols has an award equal to or lower than said base award for that symbol; and
awarding any awards associated with received predetermined winning combinations of game symbols.

6. The method in accordance with claim 5 further comprising the step of receiving at least one wager from a player to play said game.

7. The method in accordance with claim 5 wherein said first and second winning combinations of symbols comprise the same symbol in linked positions.

8. The method in accordance with claim 5 wherein said linked positions comprise symbols touching along a side, top or bottom.

9. A method of presenting a game at a gaming machine comprising the machine implemented steps of:
receiving at least one wager from a player;
displaying a first set of game symbols which includes at least two different game symbols;
determining if said first set of game symbols defines one or more first winning combinations of symbols;
awarding an award for each first winning combination of symbols received in said first set of game symbols, wherein each symbol in said first set of game symbols has a base value;
if at least one first winning combination of symbols was received, displaying a second set of game symbols where each symbol forming a first winning combination of symbols is removed and replaced;
determining if said second set of game symbols defines one or more second winning combinations of symbols; and
awarding an award for each second winning combination of symbols received in said second set of game symbols, wherein each symbol in said second set of game symbols has a higher value if it was not a winning symbol in said first set of game symbols and has a base value or lower if it was a winning symbol in said first set of game symbols.

10. The method in accordance with claim 9 wherein each award comprises one or more monetary value credits.

11. The method in accordance with claim 9 wherein said first and second sets of game symbols are displayed in a matrix of 2 or more rows and 2 or more columns.

12. The method in accordance with claim 9 wherein said steps of displaying comprise displaying upon at least one electronic video display associated with said gaming machine.
